(19) United States
(12) Patent Application Publication
(10) Pub. No.: US 2014/0054912 A1
(43) Pub. Date: Feb. 27, 2014

(54) ILLUMINATING GRABBER TOOL WITH FLEXIBLE MEMBER AND MAGNETIC ELEMENTS

(71) Applicant: LEILANI BUSTOS, Seaside, CA (US)

(72) Inventor: LEILANI BUSTOS, Seaside, CA (US)

(21) Appl. No.: 13/594,848

(22) Filed: Aug. 26, 2012

(51) Int. Cl. B25J 1/02; B25J 19/00

(52) U.S. Cl. CPC B25J 1/02; B25J 19/00
USPC 294/190; 294/106

(57) ABSTRACT

An elongate grabber tool that has a handle including an actuator on the first end of a first shaft, and grasping means located on the distal end of a second shaft. The shafts are connected together by a hinge, and linkage between the controller and engagement elements to control the grasping means is disclosed. Said second shaft includes a flexible element and an illuminating element. Said grasping means may include at least one magnetic element.

### FIELD OF THE INVENTION

The present invention relates to the field of grab and reach extending devices. The present invention more particularly relates to grabber devices which are angularly adjustable.

### BACKGROUND OF THE INVENTION

Well known in the art is a wide variety of tools designed for picking up objects or manipulating objects from a distance. A tool with an elongate handle allows manipulation of the object without the need to bend over or directly handle the object, as well as allowing the retrieval of objects from high shelves or other hard to reach areas. Another common application for such tools is for changing light bulbs from recessed lighting fixtures.

A desirable feature that is sometimes incorporated on these devices is a locking mechanism that enables the engagement hands to be retained in a fixed position. A locking feature allows the user of the device to retain the engagement elements in a closed position while in contact with an object and thereby allowing a user to release pressure on the actuator while maintaining control over the object. Consequently, the user can use their free hand to further manipulate the object, either directly or indirectly. A further desirable feature of elongated engagement tools is the ability for the device to fold or collapse. Because these devices employ an elongated rod, the devices are somewhat cumbersome in connection with shipping, handling, display and storage.

### SUMMARY OF THE INVENTION

An elongate grabber tool that has a handle including an actuator on the first end of a first shaft, and grasping means located on the distal end of a second shaft. The shafts are connected together by a hinge, and linkage between the controller and engagement elements to control the grasping means is disclosed. Said second shaft includes a flexible element and an illuminating element. Said grasping means include at least one magnetic element.

### BRIEF DESCRIPTION OF THE DRAWINGS

FIG. 1 is a side view of the present invention in a deployed in-use position and including a pair of engagement hands.

FIG. 2 is a side view of the present invention in a collapsed or storage position.

FIG. 3 is a sectional side view of the present invention.

FIGS. 4A, 4B, and 4C are all magnified detail views of aspects of the present invention.

FIG. 5 is a perspective view of the hinging means of the present invention.

FIG. 6A is a side view of the present invention.

FIG. 6B is a top view of the present invention.

FIG. 7 is a view of the magnetic capabilities of the present invention.

FIGS. 8A and 8B are views of the illumination activation system.

FIG. 9 is a perspective view of the grabber end of the present invention.

FIG. 10 is a side view of one of the engagement hands.

FIG. 11 is a sectional view of one of the engagement hands.

FIG. 12A is a side view of an alternate embodiment.

FIG. 12B is a top view of an alternate embodiment.

FIG. 13 is a detailed view of the grabber design.

FIG. 14 is an exploded view of the grabber design of FIG. 13.

FIG. 15 is a perspective view of the grabber end of the second shaft.

FIG. 16 is a perspective view of the handle including a power source.

FIG. 17 is an exploded view of the hinge.

FIG. 18 is a perspective view of the inside section of a first side of the handle of the present invention of FIG. 1.

FIG. 19 is a perspective view of the inside section of a first side of the handle with a cable, electrical wires, and locking mechanism.

FIG. 20 is a perspective view of the inside section of a second side of the handle of the present invention of FIG. 1.

FIGS. 21A and 21B are perspective views of the front and back of an optional flexible fixture, wherein the flexible feature is to removably couple with either engagement hand of FIG. 1.

### DETAILED DESCRIPTION

Referring now to FIG. 1, a first preferred embodiment of the present invention is generally depicted as device 100. Device 100 includes a handle 102 located at a first end. Said handle 102 comprises an actuator 104, and locking mechanism 106. Locking mechanism 106 is comprised of a flat spring, and a protuberance thereon. Said handle 102 also comprises a protuberance 107 which is independent of locking mechanism 106. When actuator 104 is depressed fully into handle 102, locking mechanism 106 travels within a channel of handle 102, locks at a predetermined end point, and causes protuberance 107 to protrude out from handle 102. When protuberance 107 is depressed into handle by user, locking mechanism 106 releases actuator 104 from within handle 102, subsequently releasing tension from grabber hands, and thereby releasing pressure from article being held by grabber. Affixed to said handle 102 is a first shaft 108 and a second shaft 112. First and second shafts are rotatably affixed by a locking hinge 110. FIG. 1 presents the device 100 in a deployed position wherein the locking hinge 110 is releasably placed in a first locked state and therein temporarily maintains and supports the first shaft 108 and the second shaft 112 in the deployed position and at a 180 degree relative position between the first shaft 108 and the second shaft 112. The second shaft 112 may be or comprise a suitable flexible plastic or metal tubing or length, such as, but not limited to, a Series CWH-S TM flexible braided stainless steel water supply line or an LFBK LBF-24 TM stainless steel water heater supply sine as marketed by Watts, Inc. of North Andover, Mass.

A pair of engagement hands 116 are each affixed to the second shaft 112 via non-retractable fingers 114, and each engagement hand 116 contains a magnetically charged element 118 within its entirety.

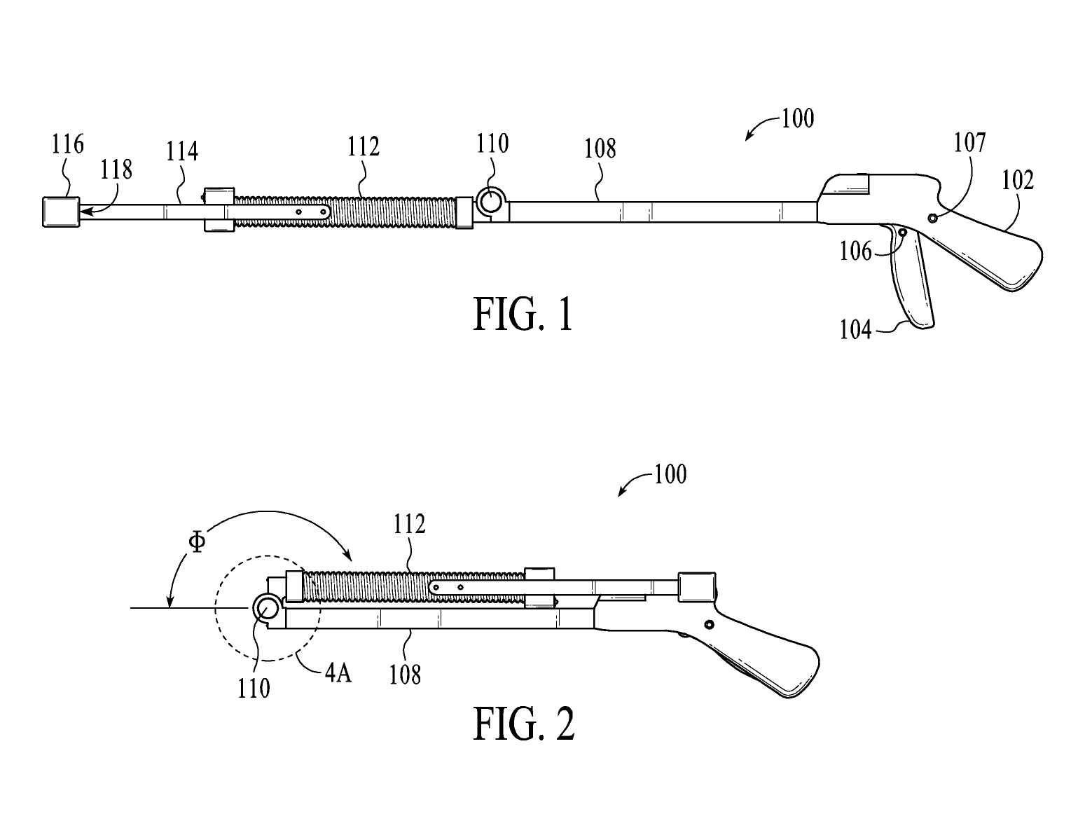

Referring now to FIG. 2, the device 100 is shown in a collapsed or storage position as demonstrated by action Phi, wherein the locking hinge 110 enables the relative rotation of the first shaft 108 and the second shaft 112 and into the collapsed position as shown. This illustrated orientation of the device 100 as shown is generally used for shipping or storage. The range of rotational motion of the pivoting locking hinge 110 into the collapsed position of FIG. 2 is shown in greater detail in FIG. 4A.

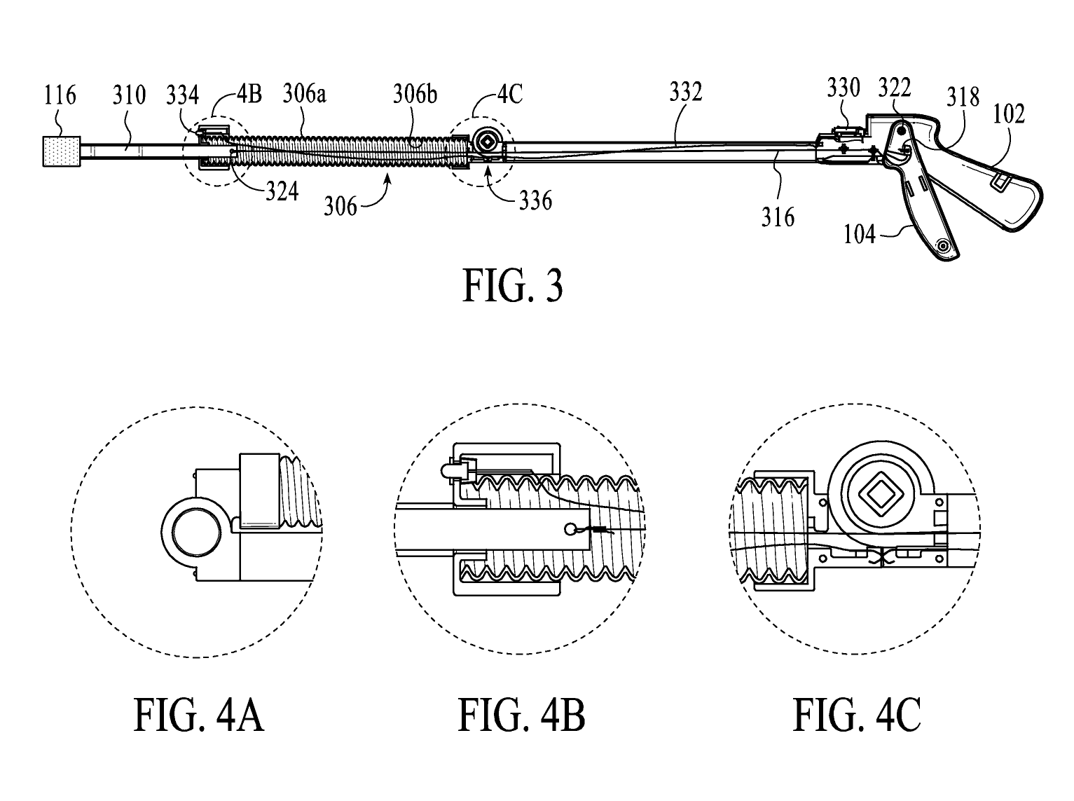

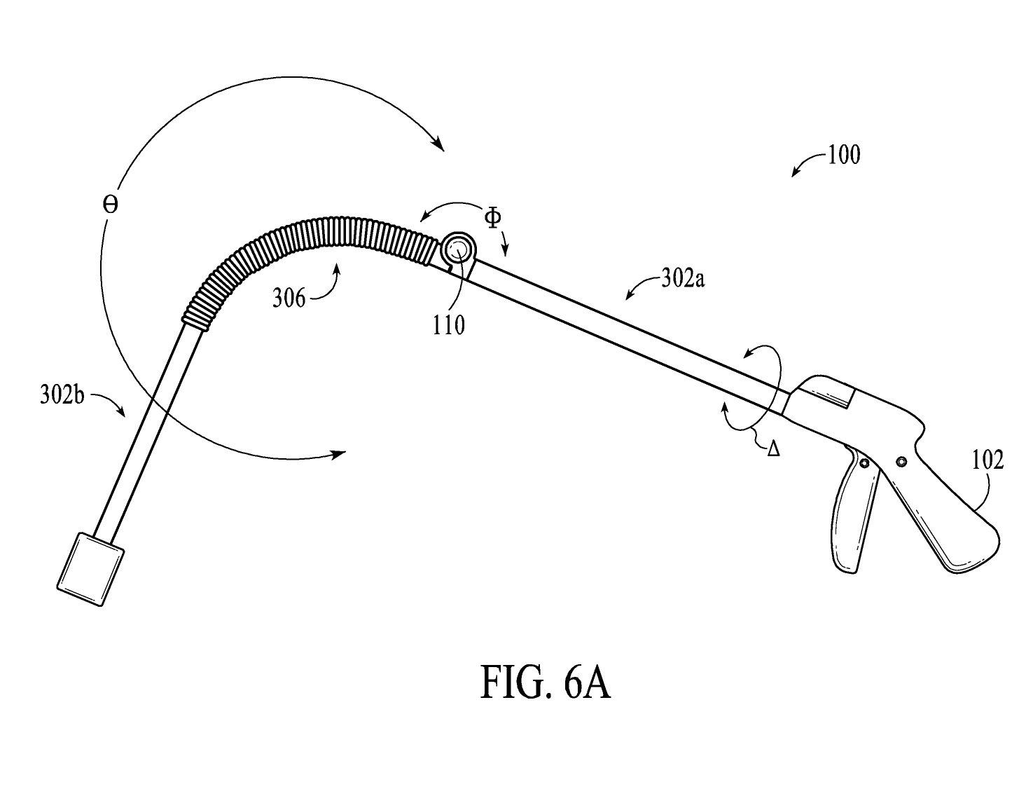

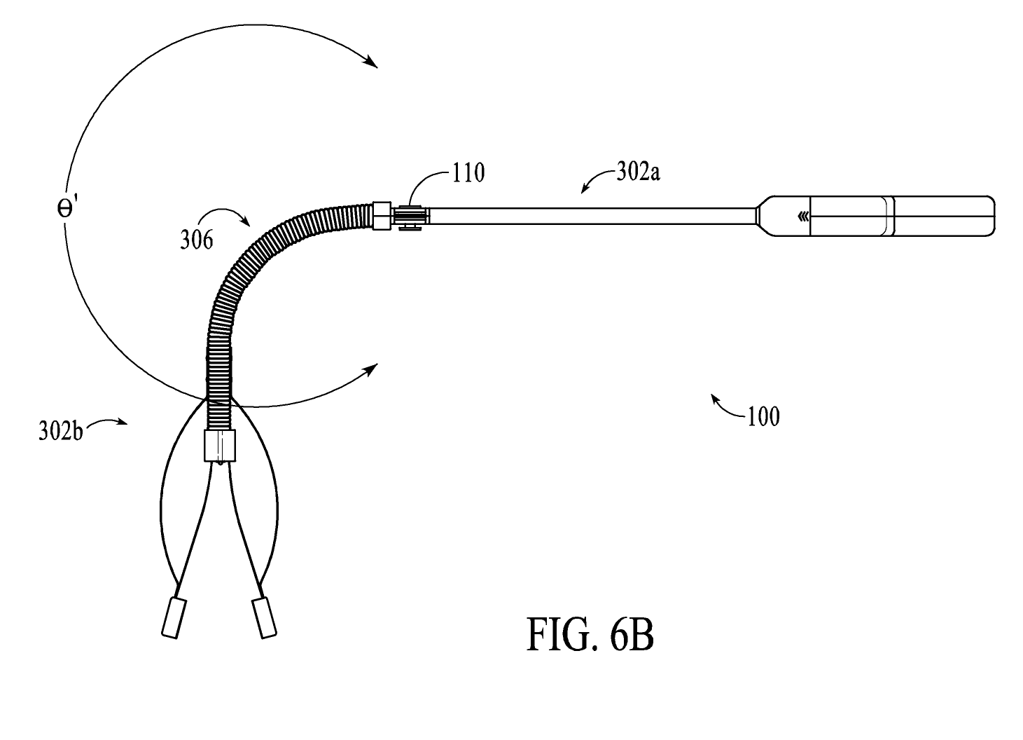

Referring now to FIG. 3, Actuator 104 is partially disposed within handle 102 and is pivotally affixed to said handle 102 at pivot point 322. Cable 316 is affixed to actuator 104 at anchor point 318. When in the in-use position (as shown here), the actuator 104 is to be squeezed into handle 102, thereby causing retractable fingers 310 to constrict and pull together via cable 316 such that engagement hands 116 come in contact with acquirable article of interest (not shown). When the apparatus of the present invention is in the collapsed position via pivotable section 336, said cable 316 is naturally pulled taught via anchor points 318 and 324, thereby causing engagement hands 116 to constrict via retractable fingers 310. An object of the present invention is to allow user to obtain articles in a manner that is not possible when using prior art grabbing systems. By incorporating a flexible shaft 306, articles can be reached that could not otherwise be reached, or articles that could be reached previously, can now be reached far easier than without said flexible shaft 306. The movement of said flexible shaft is better illustrated in FIGS. 6A and 6B. Said flexible shaft 306 comprises a flexible member 306a such as a sectional tube, conduit, or the like. Said flexible member 306a is rigid enough to support many objects. A sub-member 306b may also be employed to further strengthen said flexible shaft 306. Another object of the present invention is to provide illumination in the area of the acquirable article of interest. Said illumination is accomplished by illumination element 334, which is shown in greater detail in FIG. 4B. Said illumination element 334 is powered by an electrical supply 330 such as a battery or batteries. The electricity to power said illumination element 334 is carried through wires 332. An on/off switch is optional and not necessary. When the apparatus is in the open (in-use) position, the wires are in proximate communication at 336, which is shown in greater detail in FIG. 4C.

Referring now to FIGS. 4A, 4B and 4C wherein magnified views show greater detail that is outlined in previous FIGURES.

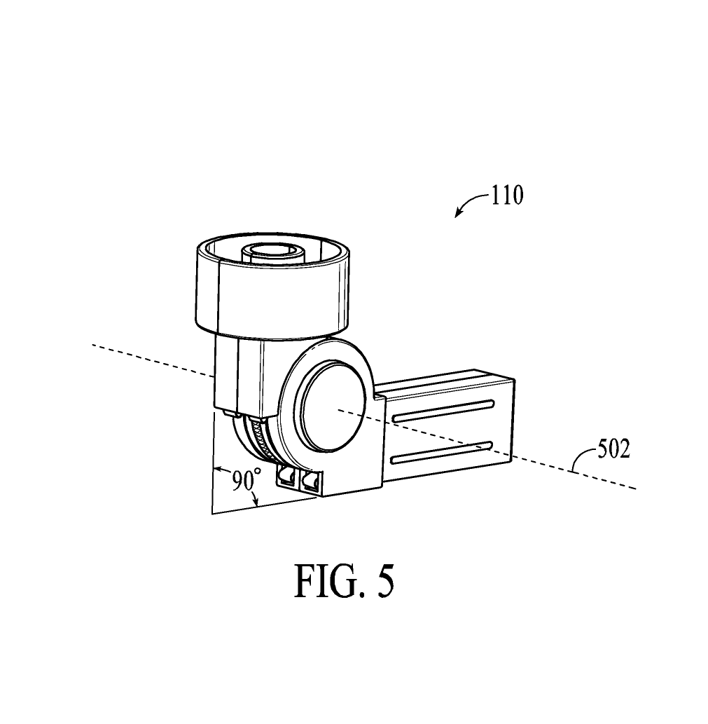

Referring now to FIG. 5, an isolated perspective view of the locking hinge 110 and in a second releasably locked position wherein the first shaft 108 and the second shaft 112 may be positioned and manipulated by a user at a 90 degree angle relative to an orthogonal axis 502.

Referring now to FIG. 6A, whereby device 100 is illustrated in an in-use orientation, and is called out in two sections 302a, and 302b. Apparatus section 302a has a first end that is pivotally attached to section 302b at the locking hinge 110 as demonstrated by the Phi motion. Apparatus section 302a also has a distal end which is affixed to handle 102. Said affixing of distal end may be removable, stationary, or pivotal to handle 102 as demonstrated by the Delta motion. In this view, flexible shaft 306 is shown as bent in a downward position, but may also bend in an upward position as demonstrated by the Theta motion. This gives the user a distinct advantage in acquiring an article of interest that is located towards the back side of a shelf, or located behind another object, or which would otherwise be unattainable if the shaft was rigid.

Referring now to FIG. 6B, wherein the device 100 is illustrated in the in-use orientation, and is called out in two sections 302a, and 302b. Apparatus section 302a is pivotally attached to section 302b at locking hinge 110. In this view, flexible shaft 306 is shown as bent in a sideways position, but may also bend to the opposite side as demonstrated by the Theta prime motion. This gives the user a distinct advantage in acquiring an article of interest that is located around a corner, or located behind another object, or which would otherwise be unattainable if the shaft was rigid.

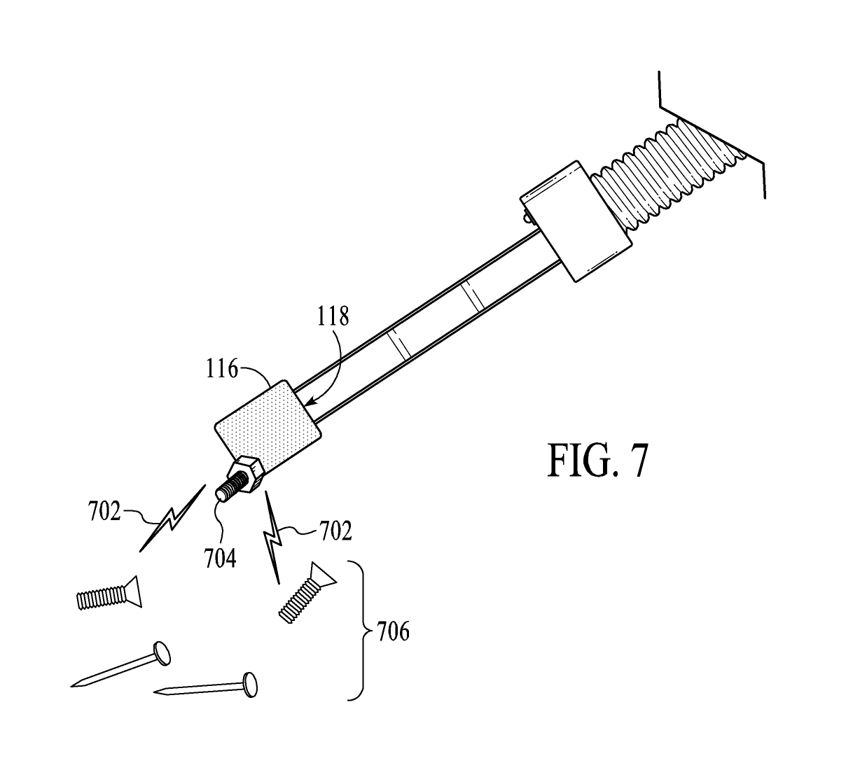

Referring now to FIG. 7, whereby engagement hand 116 includes at least one permanently charged magnetic element 118. Said magnetic element 118 is useful in acquiring small metal objects 706 without the need of actuating the apparatus of the present invention. Permanently charged, the magnet 118 releases a magnetic field 702 that, when in close proximity, draws one or more small metal objects 704 from a surface and becomes removably affixed to said magnet 118, or to the body of engagement hand 116.

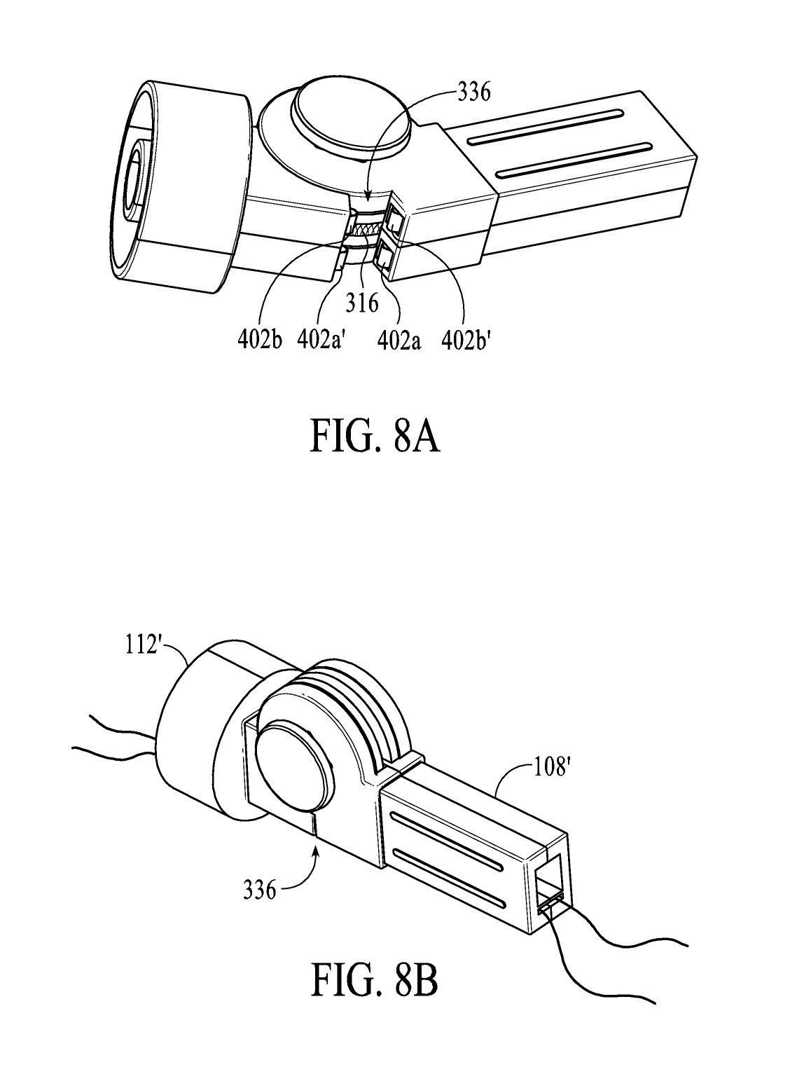

Referring now to FIG. 8A, where a detailed view of pivotable section 336 is shown. Said pivotable section 336 acts as an electrical switch that activates the illuminating element. Cable 316 is seen in greater detail as well. As shown in FIG. 3, electricity is sent through electrical wires from a power source to an illuminating member. A first wire is attached to said power source at a first end, and to a connection spring 402a at a distal end. When the apparatus of the present invention is in the in-use position, said connection spring 402a transfers the current to connector spring 402a′. A second wire is attached to connector spring 402a′ at a first end, and to an illuminating element at a distal end. Said illuminating element has a returning current wire attached as well. Said returning current wire (a third wire) is attached to the illuminating element at a first end, and to connecting spring 402b at a distal end. A fourth electrical wire is attached to connector spring 402b′ at a first end, and returns current to the power supply at a distal end. It is easily seen here that when the apparatus of the present invention is in the collapsed (storage) position, electrical power to the illuminating element is lost, and illuminating element is thereby turned off. Referring now to FIG. 8B, pivotable section 336 is shown in the engaged position. Wires are shown trailing from the shafts 108′, and 112′. In this position, the circuit will be complete and the illuminating element 334 (not shown) will be activated.

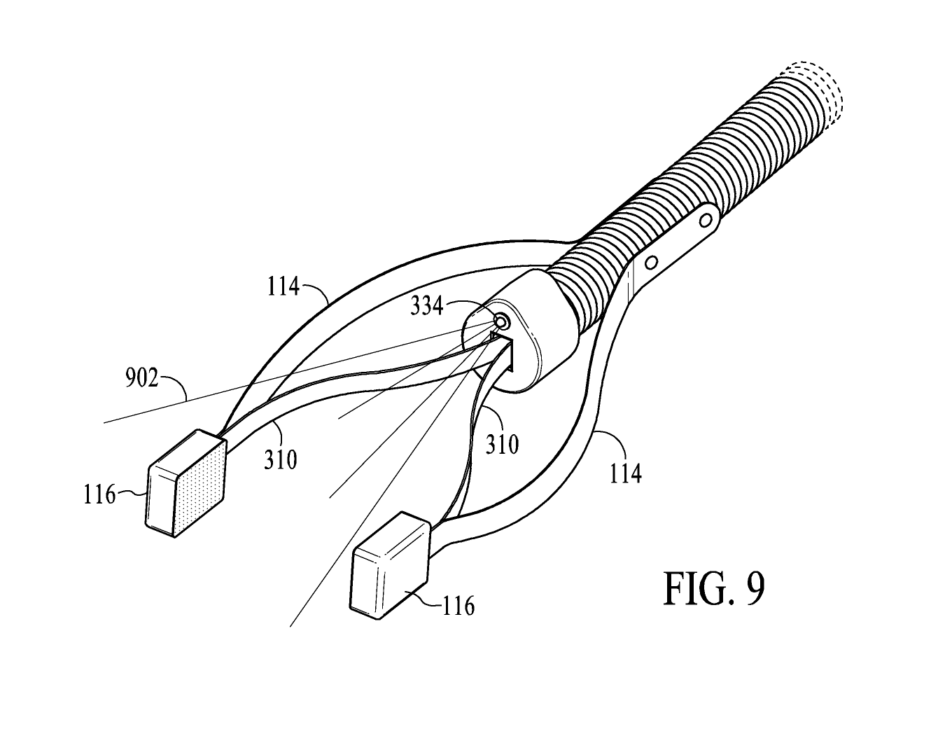

Referring now to FIG. 9, engagement hands 116 are affixed to retractable fingers 310 which are cable-drawn, as well as non-retractable fingers 114. Illuminating element 334 is shown. When in-use, illuminating element 334 radiates illumination 902 so that user can easily see into dark areas such as cupboards, closets, and under furniture.

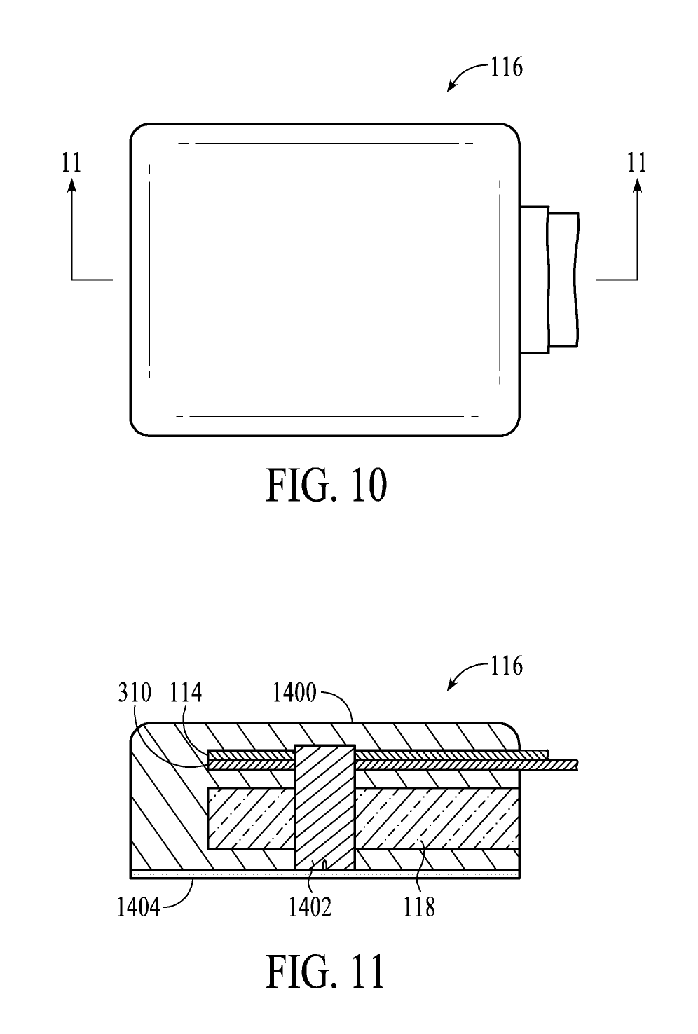

Referring now to FIG. 10, FIG. 10 illustrates a section cut along an internal plane 11 that extends through an exemplary engagement hand 116.

Referring now to FIG. 11, FIG. 11 presents the exemplary hand 116 as being composed of multiple parts. The hand 116 includes a housing 1400. A pin 1402 extends through apertures of the housing 1400, the magnetically charged element 118, the retractable finger 310 and the non-retractable finger 114 and maintains these elements 310, 114 & 118 in a coupled state with the housing 1400. A friction pad 1404 caps off the pin 1402 as positioned within the housing 1400. The friction pad 1404 additionally allows for a better compressive grip on small objects that the present invention may be employed to grab. Fingers 114 and 310, as well as magnet 118 can be affixed to or within the exemplary engagement hand 116 by a variety of suitable methods and structures known in the art.

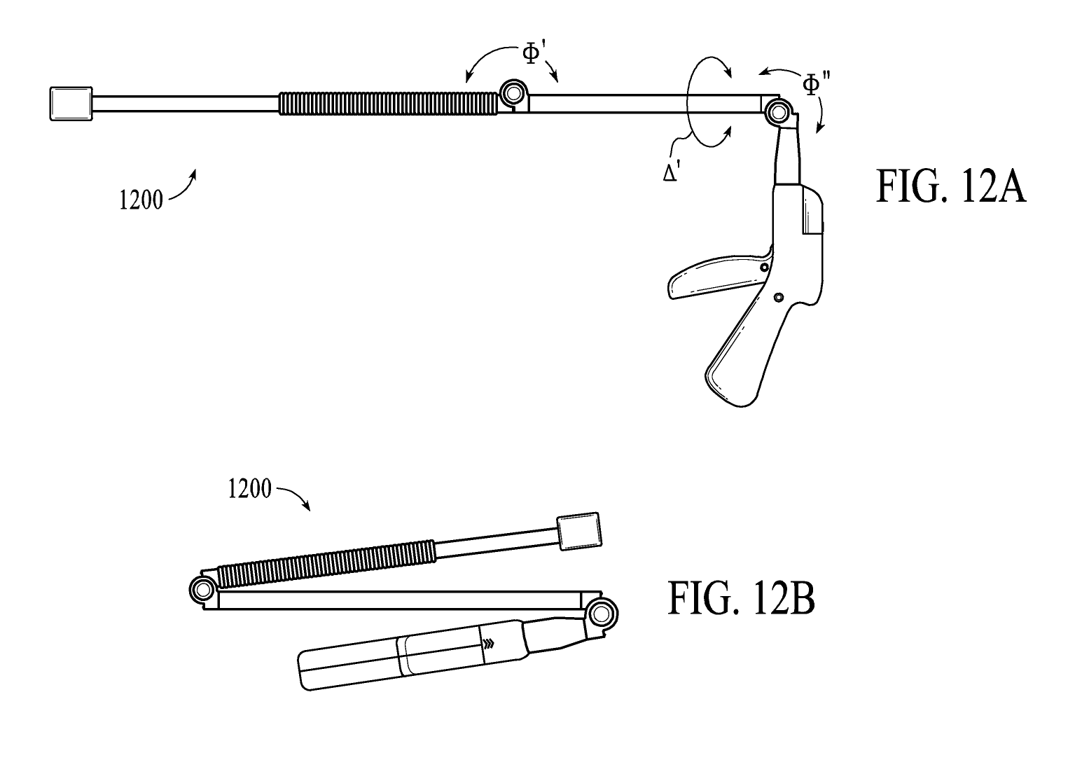

Referring now to FIGS. 12A and 12B, an alternate embodiment is generally shown as 1200. FIG. 12A shows pivot means phi prime, delta prime, and phi double prime. Applying action to said pivot means allows this embodiment to become collapsible. The configuration shown in FIG. 12B is almost completely collapsed. Collapsed position is generally used for shipping or storage. The configuration of FIG. 12A shows a first pivot action at phi double prime. While this configuration is generally the first in the series of collapsible pivoting actions, it also demonstrates a ‘use’ position. While in this position, a user may hold handle upright (as shown) in order to reach items located at the far back edge of a shelf. By inverting entire apparatus 1200 via the delta prime axis 180 degrees, such that handle 102′ is upside down from what is shown, user may retrieve (as outlined in previous embodiments) items from underneath a bed, dresser, automobile, etc. that are stowed or that have dropped and rolled underneath such objects.

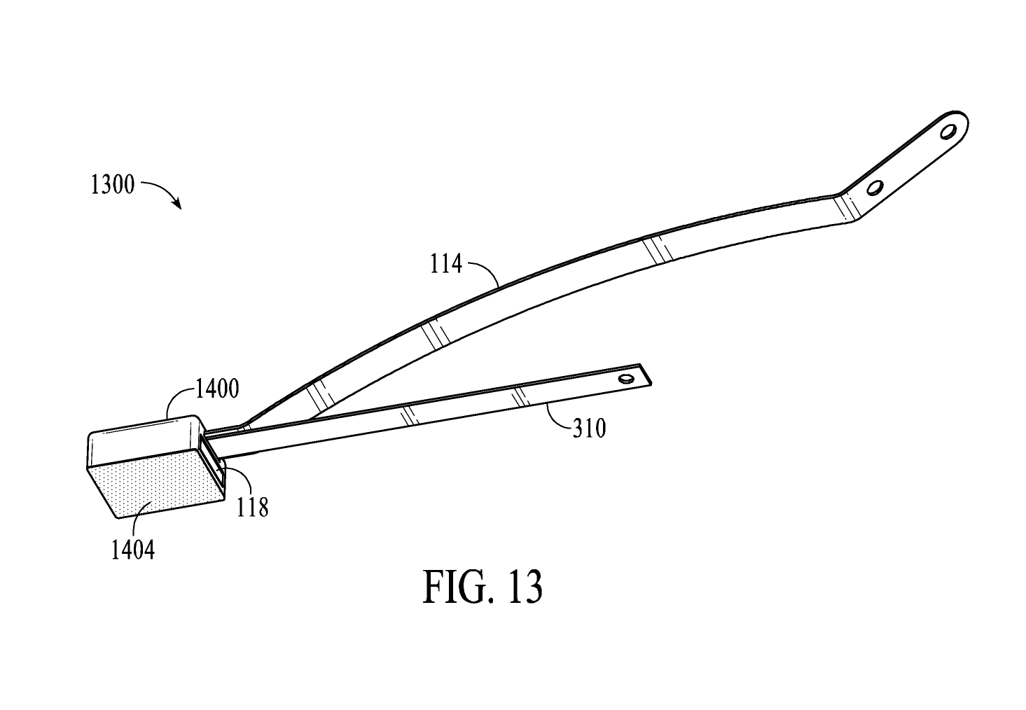

Referring now to FIG. 13, an detailed view of a first portion of the grabber design 1300. The grabber design 1300 includes retractable finger 310, non-retractable finger 114, a housing 1400, a friction pad 1404, and at least one magnetically charged element 118.

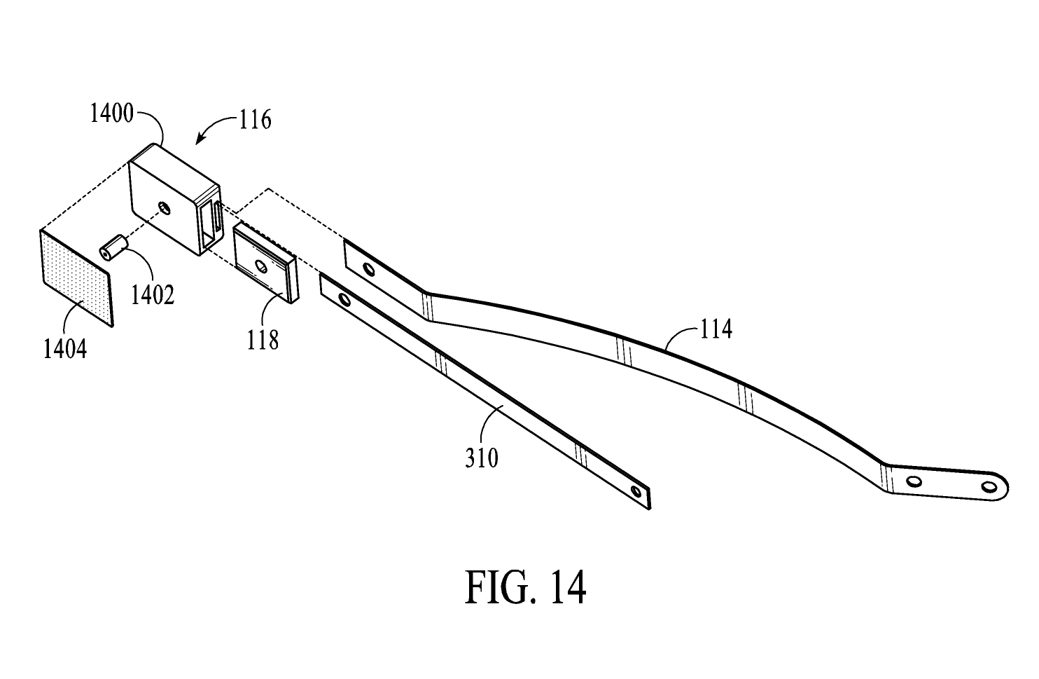

Referring now to FIG. 14, an exploded view of the detail of the grabber design of FIG. 13. The hand 116, is composed of multiple parts. The hand 116 includes a housing 1400, which contains at least one magnetically charged element 118, as well as secures retractable finger 310, and non-retractable finger 114. These components are retained by a pin or a screw 1402, and capped off with a friction pad 1404. The friction pad 1404 allows for better grip on small objects that the present invention may be employed to grab.

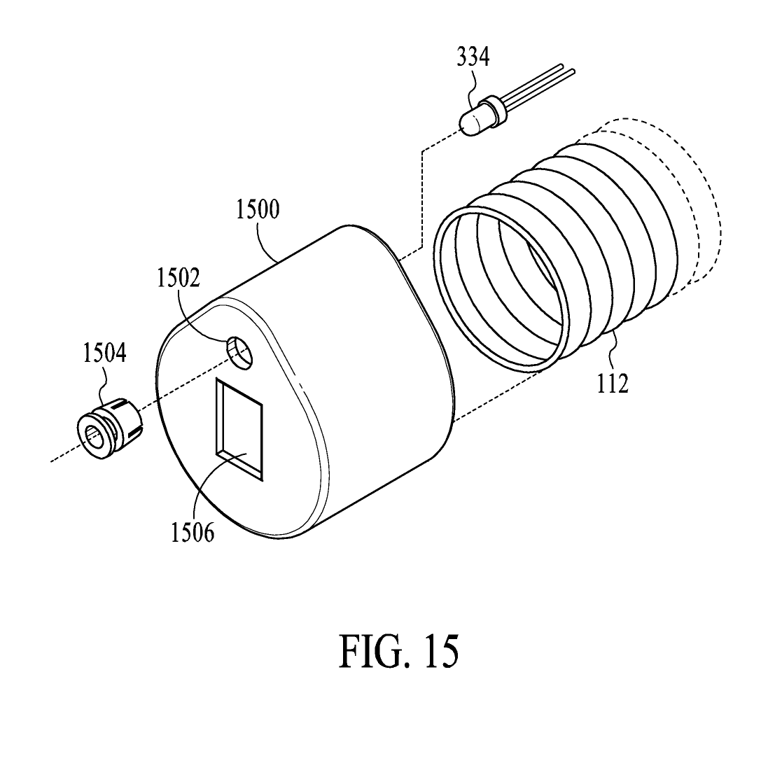

Referring now to FIG. 15, a view of the grabber end 1500 of the second shaft 112. The grabber end 1500 of the second shaft 112 may be configured to have a light emitting element 334 which is secured in a first aperture 1502 by a grommet 1504. A second aperture 1506 is configured to receive the retractable fingers 310 and cable 316 (not shown).

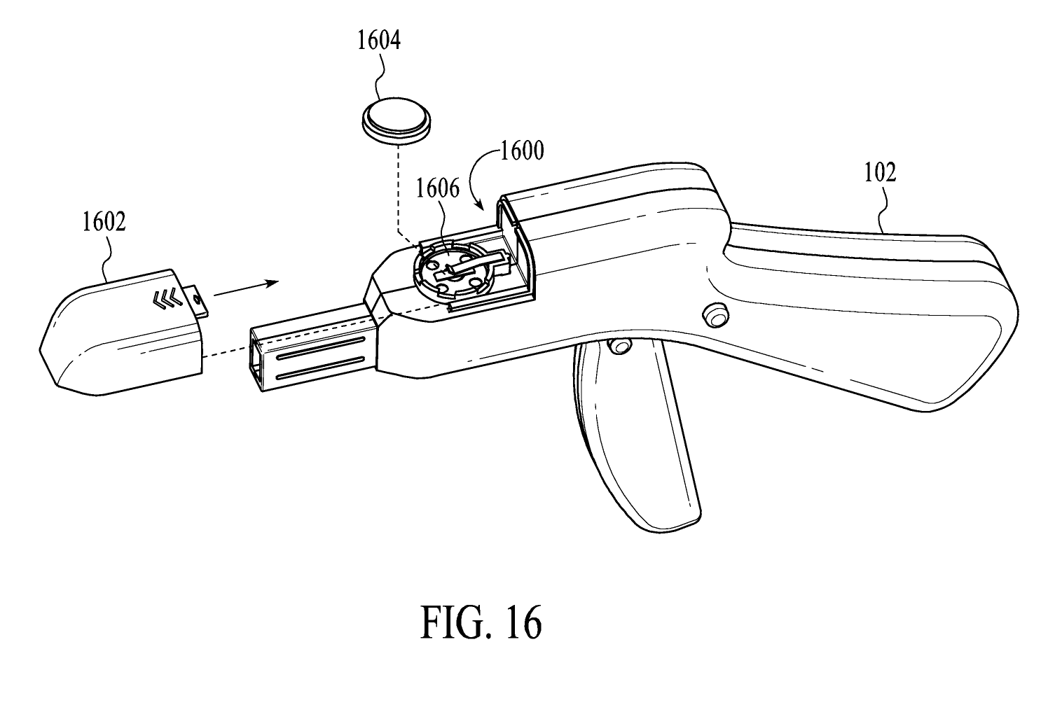

Referring now to FIG. 16, a view of the handle 102 including a power source. The handle 102 is optionally configured to incorporate a battery compartment 1600, covered by a battery cover 1602, wherein a battery 1604 would be coupled to battery holder 1606 in order to power the light emitting element 334 (not shown). Although the electrical supply shown here is located within the handle, those skilled in the art will see that the electrical supply may easily be located within other parts such as the hinge, grabber end, or located independently of elements described herein.

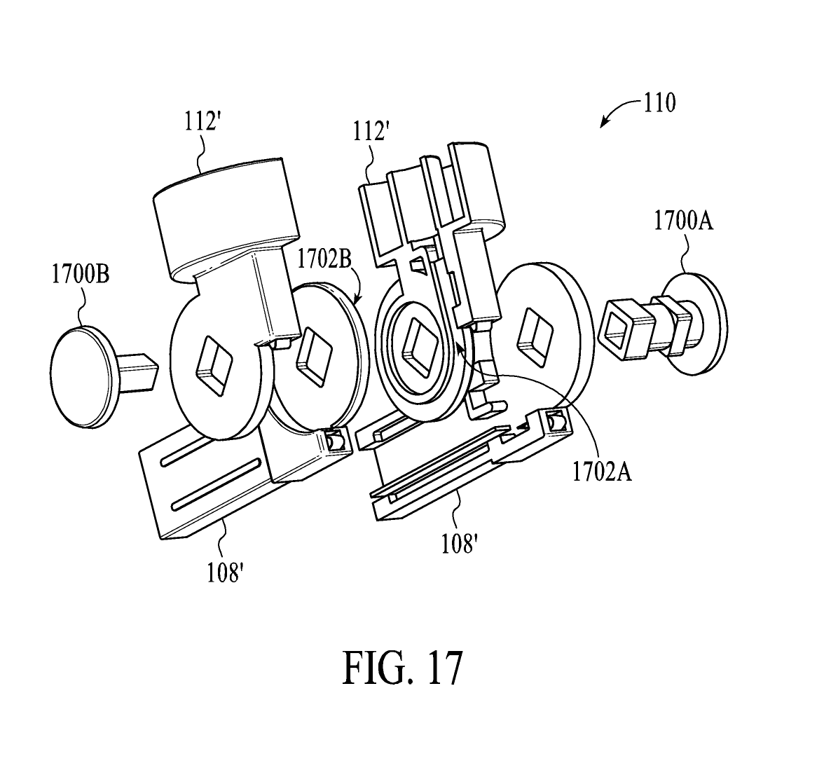

Referring now to FIG. 17, an exploded view of the locking hinge 110. The locking hinge 110 is composed of links to the first shaft 108′ and foldably links to the second shaft 112′ held together by pin 1700A and 1700B which may allow either pivoting or locking of said links. Within the links to the second shaft 112′ is a cable channel 1702A adapted to receive the cable 316 (not shown). A corresponding cable channel is found on the links to the first shaft 108′ at 1702B (not seen from this perspective).

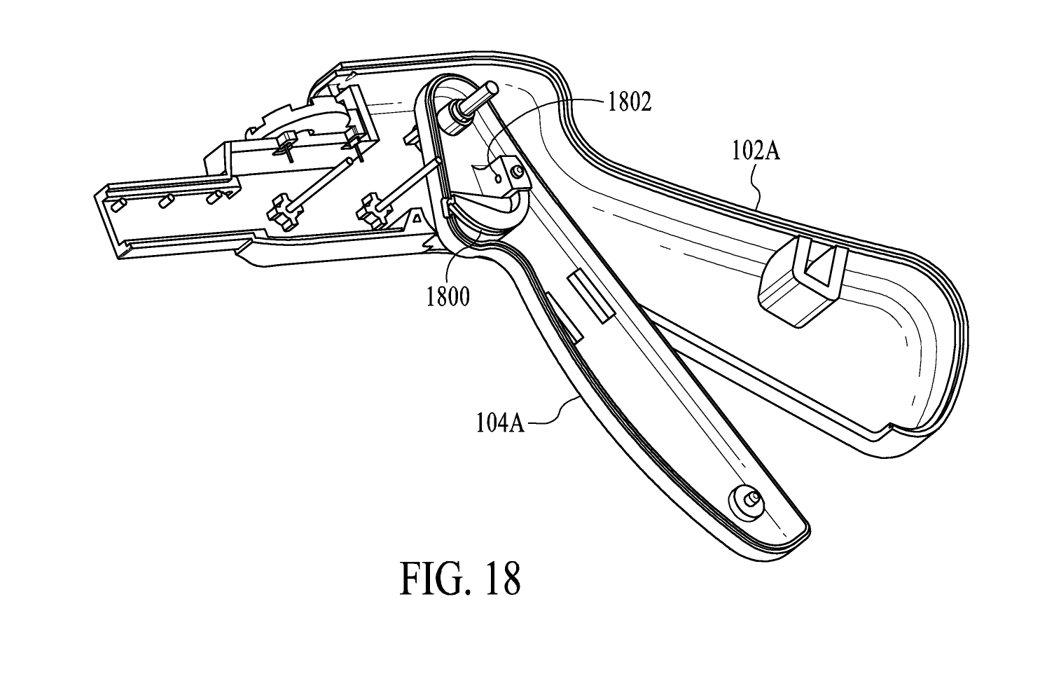

Referring now to FIG. 18, an inside view of a first side 102A of the handle 102. The actuator side 104A is inserted into the handle 102 internally includes an arced cable channel 1800. The cable channel 1800 allows the cable 316 to be directionally secured to the actuator side 104A. The arced design provided for additional mechanical force. Cable 316 is threaded through secure point 1802, and subsequently affixed to actuator side 104A.

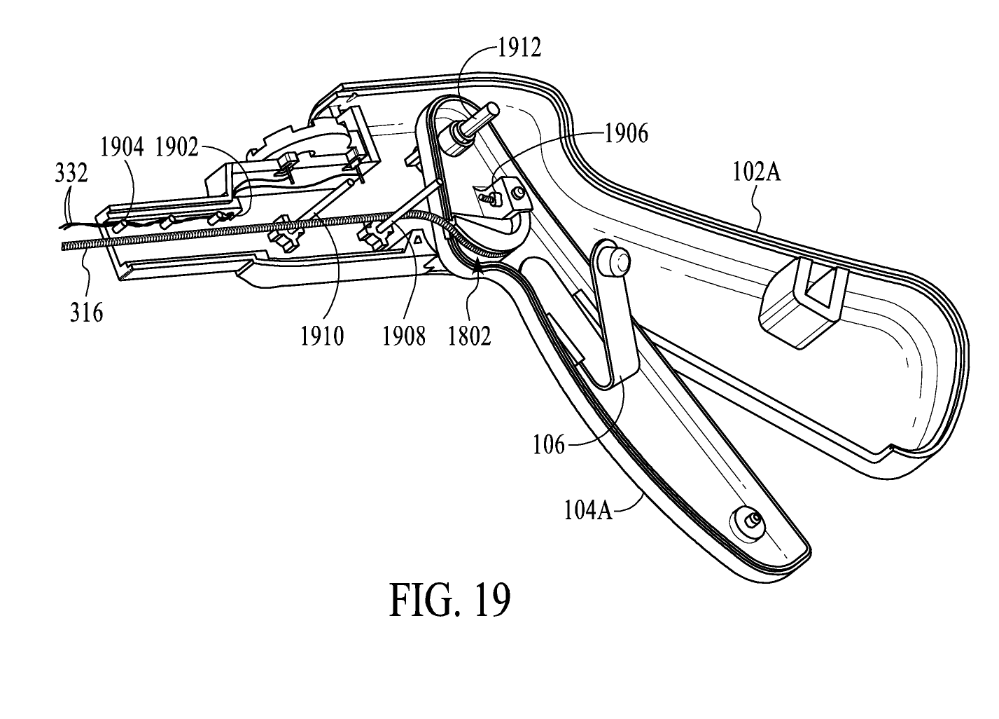

Referring now to FIG. 19, a perspective view of the inside of the first side 102A of the handle 102 configured with the cable 316 and the electrical wires 332. A guide hole 1902 and a series of guide pins 1904 maintain the electrical wires 332 in a stable position within the first side 102A. An attachment nut 1906 anchors the cable 316 in position relative to the cable channel 1800 and thereby anchors the cable 316 within the actuator 104A. A pair of guideposts 1908 & 1910 support and guide the cable 316 as the cable 316 may move within the handle 102. The actuator 104 is rotatably coupled with an actuator post 1912 whereby the actuator 104 may be manually squeezed by a user to cause the actuator 104 to rotate about the actuator post 1912 and the cable 316 is pulled into the handle 102. Locking mechanism 106 is also secured to actuator side 104A. The protuberance thereon protrudes through the aperture of the corresponding handle side (not shown).

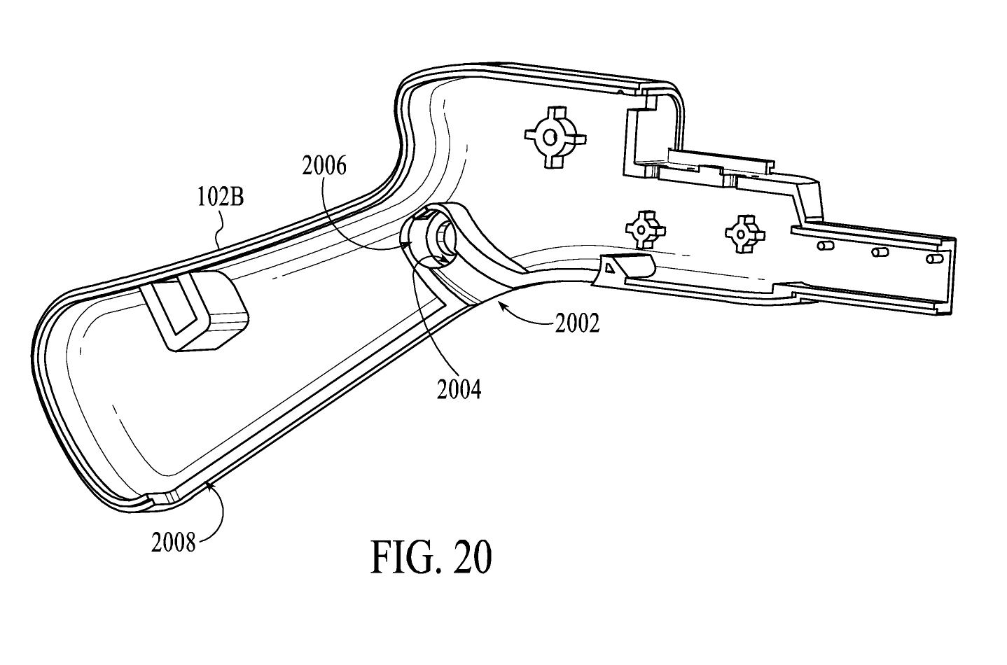

Referring now to FIG. 20, a perspective view of the inside of a second side 102B of the handle 102. The second side 102B is joinable with the first side 102A to form the handle 102. Channel 2002 accepts the protuberance of locking mechanism 106 and slot 2008 accepts actuator 104. Said protuberance travels up the channel 2002. Upon reaching the top of channel 2002, the locking mechanism decompresses, thereby driving the protuberance thereon into chamber 2006 whereby it rests upon ledge 2004 of chamber 2006 thus locking the actuator within the handle.

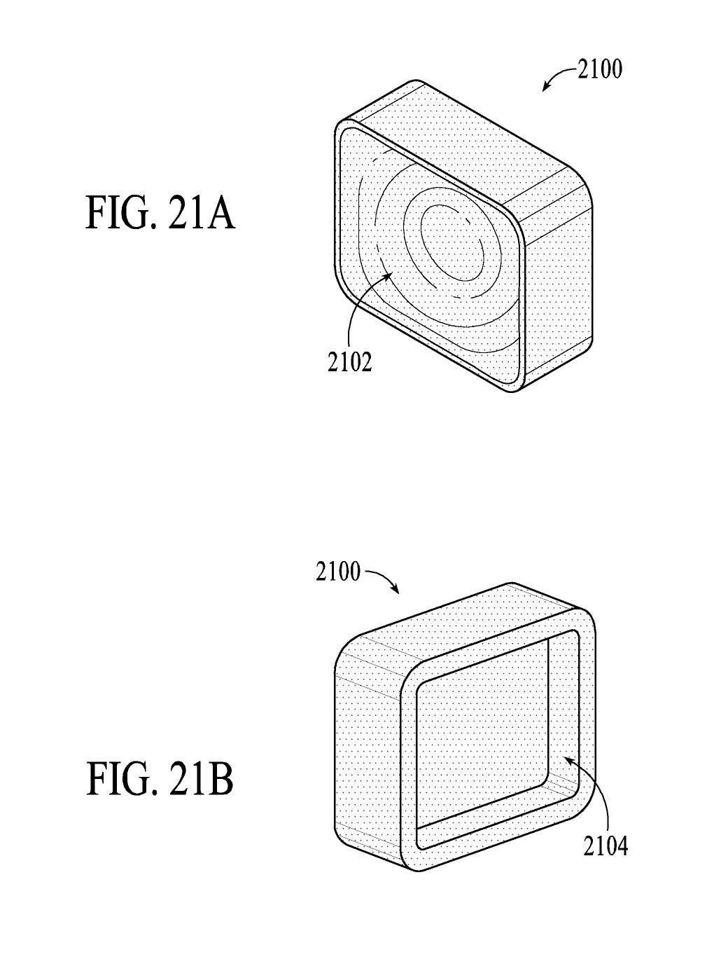

FIG. 21A and 21B are perspective views of the front and back of an optional flexible fixture 2100, wherein the flexible feature 2100 is adapted, sized and shaped to removably couple with either engagement hand of FIG. 1.

Referring now to FIG. 21A, an elastic external side 2102 of the flexible feature 2100 is adapted to elastically engage with, compress against and grasp an object in combination with a second flexible feature 2100 when each of the flexible features are coupled to separate engagement hands 116.

Referring now to FIG. 21B, an elastic internal side 2104 of the flexible feature 2100 is adapted to removably couple with a single engagement hand 116 of the device 100.

While the preferred embodiments have been described herein, those skilled in the art will recognize that certain details may be changed without departing from the spirit and scope of the invention. Thus, the foregoing specific embodiments and applications are illustrative only and are not intended to limit the scope of the invention. It is contemplated that the invention would be functional and effective in diverse applications where it is desirable to acquire objects that cannot be acquired using conventional grabbing tools as well as acquire objects in the dimly lit areas, and provide magnetic means to acquire small metal objects without the need to actuate the apparatus.

I claim:

1. A device comprising:
a flexible elongate shaft (“shaft”), the shaft adapted for manual deformation in at least two orthogonal dimensions, the shaft having a handle end and a grabber end;
a grabber feature, the grabber feature coupled to the shaft grabber end, the grabber feature adapted to apply force to temporarily couple with an object;
a handle, the handle coupled to the shaft handle end; and
an actuator, the actuator having a user end and a grabber end, the user end coupled with the handle and adapted to accept and transfer mechanical force to the grabber end, and the grabber end coupled with the grabber feature and adapted to accept and transfer mechanical force from the user end to the grabber feature.

2. The device of claim 1, wherein the shaft may rotate in relation to the handle on an axis orthogonal to the two orthogonal dimensions of deformation.

3. The device of claim 1, wherein the shaft further comprises a first intermediate elongate length (“first length”), and a second deforming length (“second length”), the first length is ridged and the second length may is adapted for said manual deformation.

4. The device of claim 3, further comprising a hinge, the hinge adapted to rotatably couple the first length and the second length.

5. The device of claim 4, wherein the hinge enables folding movement of the second length in relation to the first length.

6. The device of claim 1, further comprising a magnet, the magnet coupled to the grabber feature.

7. The device of claim 1, further comprising a light emitting module, the light emitting module coupled to the shaft grabber end.

8. The device of claim 5, further comprising a light emitting module, the light emitting module coupled to the shaft grabber end, wherein the light emitting module is automatically turned on when the shaft and the first length are in an un-folded position.

9. The device of claim 8, further comprising a magnet, the magnet coupled to the grabber feature.

10. The device of claim 1, where the actuator is configured to be lockable at a degree of actuation.

11. A device comprising:
a flexible elongate shaft (“shaft”), the shaft having a rigid length and a deformable length, the deformable length adapted for manual deformation in at least two orthogonal dimensions, the rigid length having a handle end and the deformable length having a grabber end;
a grabber feature, the grabber feature coupled to the shaft grabber end, the grabber feature adapted to apply force to temporarily couple with an object;
a handle, the handle coupled to the shaft handle end; and
an actuator, the actuator having a user end and an grabber end, the user end coupled with the handle and adapted to accept and transfer mechanical force to the grabber end, and the grabber end coupled with the grabber feature and adapted to accept and transfer mechanical force from the user end to the grabber feature.

12. The device of claim 11, wherein the rigid length and the deformable length are rotatably coupled.

13. The device of claim 12, shaft further comprising a hinge, the hinge disposed between the rigid length and the deformable length, and the hinge adapted to rotatably couple the rigid length and the deformable length.

14. The device of claim 13, device further comprising a second hinge, the second hinge disposed between the handle and the shaft, and the second hinge adapted to rotatably couple the handle and the shaft.

15. The device of claim 13, further comprising a light emitting module, the light emitting module coupled to the shaft grabber end and adapted to automatically illuminate when the hinge is placed in an engaged position.

16. The device of claim 15, further comprising a magnet, the magnet coupled to the grabber feature.

17. The device of claim 11, further comprising a light emitting module, the light emitting module coupled to the shaft grabber end.

18. The device of claim 17, further comprising a magnet, the magnet coupled to the grabber feature.

19. A device comprising:
a compressing feature, the compressing feature adapted to apply compressing force to temporarily couple with an object;
a deformable shaft, the deformable shaft coupled with the compressing feature and adapted to position the compressing feature;
an actuator, the actuator coupled with the compressing feature and adapted to accept tension force and provide compressive force to the compressing feature; and
a handle, the handle coupled to the actuator and adapted to receive manual pressure and provide tension force to the actuator.

20. The device of claim 19, further comprising a light, the light coupled with deformable shaft, positioned such that the light illuminates the compressing feature.
